(19) United States
(12) Patent Application Publication
(10) Pub. No.: US 2022/0252000 A1
(43) Pub. Date: Aug. 11, 2022

(54) ENGINE, OUTBOARD MOTOR, AND WATERCRAFT

(71) Applicant: HONDA MOTOR CO., LTD., Tokyo (JP)

(72) Inventors: Shohei Kono, Wako-shi (JP); Koji Nakagawa, Wako-shi (JP); Koji Kasai, Wako-shi (JP); Takaaki Kato, Wako-shi (JP); Masami Okubo, Wako-shi (JP); Gendai Matsuoka, Wako-shi (JP); Hideta Muramatsu, Wako-shi (JP)

(21) Appl. No.: 17/563,778

(22) Filed: Dec. 28, 2021

(30) Foreign Application Priority Data
Feb. 5, 2021 (JP) 2021-017521

(51) Int. Cl. F02B 61/04; F01M 9/10; F01L 1/18

(52) U.S. Cl. CPC F02B 61/045; F01M 9/101; F02B 75/007; F01L 1/18; F01M 9/107

(57) ABSTRACT

An engine includes: a crankshaft disposed vertically; a piston that is connected to the crankshaft via a connecting rod and reciprocates in a cylinder; a cylinder head forming a combustion chamber of the cylinder at an end face of a movable portion of the piston; an intake valve and an exhaust valve disposed at the cylinder head, the intake valve being configured to take in fuel-air mixture, which is a mixture of fuel and air, the exhaust valve being configured to exhaust the fuel-air mixture; a low-rotation rocker arm (rocker arm) that drives the intake valve and the exhaust valve by rotation of a cam shaft; and a rocker shaft that supports the low-rotation rocker arm such that the low-rotation rocker arm is swingable, and an oil holding portion extending in an axial direction of the rocker shaft is provided between the rocker shaft and the low-rotation rocker arm.

### INCORPORATION BY REFERENCE

The present application claims priority under 35 U.S.C. § 119 to Japanese Patent Application No. 2021-017521 filed on Feb. 5, 2021. The content of the application is incorporated herein by reference in its entirety.

### BACKGROUND OF THE INVENTION

### Field of the Invention

The present invention relates to engines, outboard motors, and watercraft, and particularly to an engine, an outboard motor, and a watercraft in which rocker arms for driving engine valves can be properly lubricated.

### Description of the Related Art

There have been disclosed techniques (for example, refer to Japanese Utility Model Laid-Open No. 59-137309) in which a rocker arm for driving an engine valve is swingably supported by a rocker shaft, and the outer peripheral surface of the rocker shaft has an annular main oil groove extending in the circumferential direction of the rocker shaft and communicating with an oil hole.

However, nowadays, there are known valve lift and timing switching mechanisms that hydraulically change the lift distance of the intake valve between when the engine is driven in low rotation speed and when in high rotation speed. In such techniques, to prevent erroneous operation at low rotation speed, the oil pressure at low rotation speed is set lower than in normal operation.

In such techniques, the engine includes rocker arms used at low rotation speed and rocker arms used at high rotation speed, but the loads generated at the bearing portions of the rocker arms are large not only at high rotation speed but also at low rotation speed.

In addition, it can be said that since the movement of the rocker arm is not rotary motion but swing motion, the phenomenon of wedge effect of lubrication oil is less likely to occur, and thus it is a severe condition as bearing lubrication. Further, since the load generated on the rocker arm is not in a reciprocating direction but always from one side, a gap is less likely to occur at the bearing portion on the load side.

Under such a low oil pressure and high load condition, the lubrication oil from an oil supply hole is less likely to seep out in the direction of the shaft supporting the rocker arm, and a gap due to the load direction is also less likely to occur. Thus, the oil film is likely to discontinue at portions other than the portions in the circumferential direction of the oil supply hole portion.

For this reason, there is a problem that even if an annular oil groove is provided as in the conventional technique, enough lubrication oil cannot be supplied to the lower surface side of the rocker arm where the load is concentrated, and the lubrication oil cannot be held on the lower surface side of the rocker arm.

The present invention has been made in light of the aforementioned situation, and an object thereof is to provide an engine, an outboard motor, and a watercraft in which oil can be supplied to rocker arms for low rotation speed.

### SUMMARY OF THE INVENTION

To achieve the object, an engine according to an aspect of the present invention includes: a crankshaft disposed vertically; a piston that is connected to the crankshaft via a connecting rod and reciprocates in a cylinder; a cylinder head forming a combustion chamber of the cylinder at an end face of a movable portion of the piston; an intake valve and an exhaust valve disposed at the cylinder head, the intake valve being configured to take in fuel-air mixture, which is a mixture of fuel and air, the exhaust valve being configured to exhaust the fuel-air mixture; a rocker arm that drives the intake valve and the exhaust valve by rotation of a cam shaft; and a rocker shaft that supports the rocker arm such that the rocker arm is swingable, and an oil holding portion extending in an axial direction of the rocker shaft is provided between the rocker shaft and the rocker arm.

In the foregoing configuration, the oil holding portion communicates with an oil supply hole.

In the foregoing configuration, the oil holding portion is formed on an outer peripheral surface of the rocker shaft.

In the foregoing configuration, the oil holding portion has a length shorter than a width dimension of the rocker arm.

In the foregoing configuration, the width of the oil holding portion in the circumferential direction of the rocker arm is approximately the same as the diameter of an oil supply hole.

In the foregoing configuration, the oil holding portion has an approximately oval shape extending in an axial direction of the rocker arm, and the width of the oil holding portion in the circumferential direction is the same as the diameter of the oil supply hole.

In the foregoing configuration, a wound bush member is provided on a surface of the rocker arm, the surface being configured to slide on the rocker shaft, and the oil holding portion is formed in the wound bush member.

In the foregoing configuration, the rocker arm includes low-rotation and high-rotation rocker arms of the engine, and the oil holding portion is formed at a portion corresponding to the low-rotation rocker arm.

An outboard motor according to an aspect of the present invention includes the engine according to claim 1.

A watercraft according to an aspect of the present invention includes the outboard motor according to claim 9.

With an aspect of the present invention, providing the oil holding portion makes it possible to hold oil between the rocker shaft and the rocker arm, to prevent the occurrence of oil leakage, and to supply oil to the entire area of a portion of the rocker arm, the portion corresponding to the rocker shaft, even under low oil pressure and high load conditions.

### BRIEF DESCRIPTION OF THE DRAWINGS

FIG. 1 is a vertical cross-sectional view of an embodiment of an engine used for an outboard motor according to the present invention;

FIG. 2 is a transverse cross-sectional view of the engine of the present embodiment;

FIG. 3 is a plan view of a rocker arm portion of the present embodiment;

FIG. 4 is a side view of a rocker arm portion of the present embodiment;

FIG. 5 is an enlarged cross-sectional view of a rocker shaft portion of the present embodiment; and

FIG. 6 is a perspective view of a modification example of the present invention.

### DETAILED DESCRIPTION OF THE PREFERRED EMBODIMENT

Hereinafter, an embodiment of the present invention will be described with reference to the drawings.

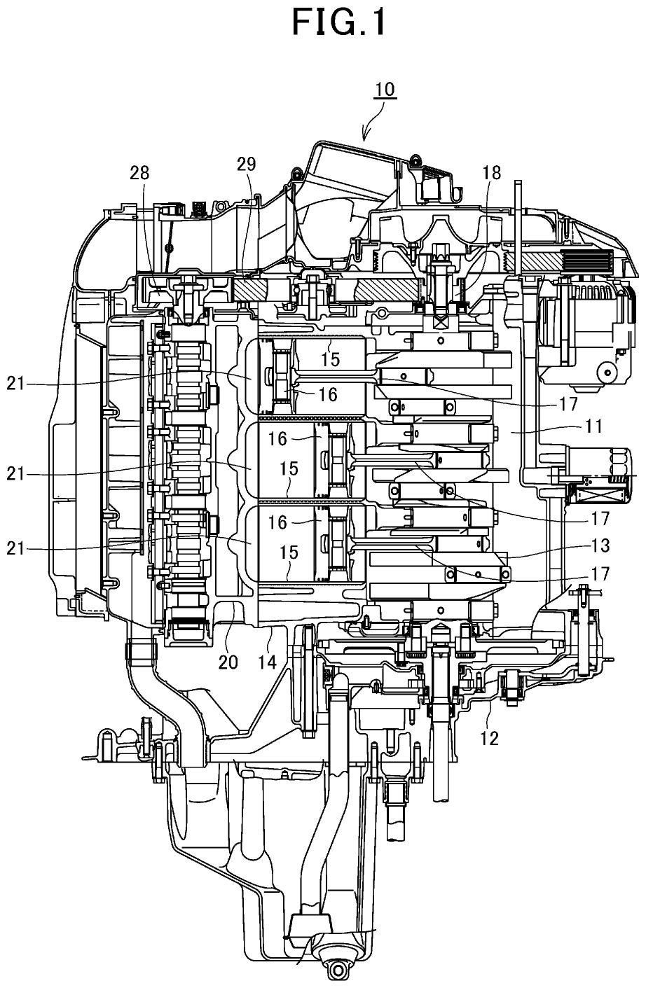

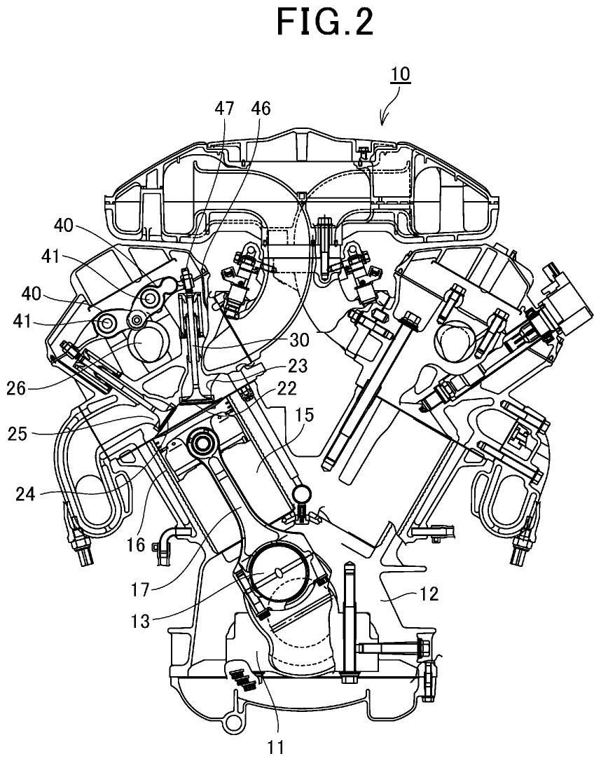

First, an engine used for an outboard motor of the present invention will be described with reference to FIGS. 1 and 2.

FIG. 1 is a vertical cross-sectional view of an embodiment of the engine. FIG. 2 is a transverse cross-sectional view of the engine of the present embodiment.

As illustrated in FIGS. 1 and 2, an engine 10 is a V6 water-cooled 4-stroke engine in which three cylinders 15 are arranged in a V configuration.

The engine 10 includes a crank case 12 that forms a crank room 11. The crank case 12 supports a rotatable crankshaft 13.

Each cylinder 15 in a cylinder block 14 houses a piston 16 such that the piston 16 can reciprocate, and each piston 16 is connected to the crankshaft 13 via a connecting rod 17.

The engine 10 is configured to be housed in a housing of a not-illustrated outboard motor. The crankshaft 13 is configured to be connected to a screw via a not-illustrated power transmission mechanism such that the rotation of the crankshaft 13 rotates the screw.

A cylinder head 20 has, for each cylinder 15, a combustion chamber 21 formed to face the piston 16, intake ports 23 that are open to the combustion chamber 21 and are opened and closed by a pair of intake valves 22, and exhaust ports 25 that are opened and closed by a pair of exhaust valves 24.

Each intake valve 22 and each exhaust valve 24 are driven to open and close by cams 27 provided on a cam shaft 26 rotatably supported by the cylinder head 20 and rocker arms 40 that are in contact with the cams 27.

The cam shaft 26 has a cam sprocket 28 at its right end, and a timing belt 29 is stretched on the cam sprocket 28 and a drive sprocket 18 attached by fitting at a portion of the crankshaft 13 near its right end.

With this configuration, each intake valve 22 and each exhaust valve 24 are driven to open and close in synchronization with the rotation of the crankshaft 13.

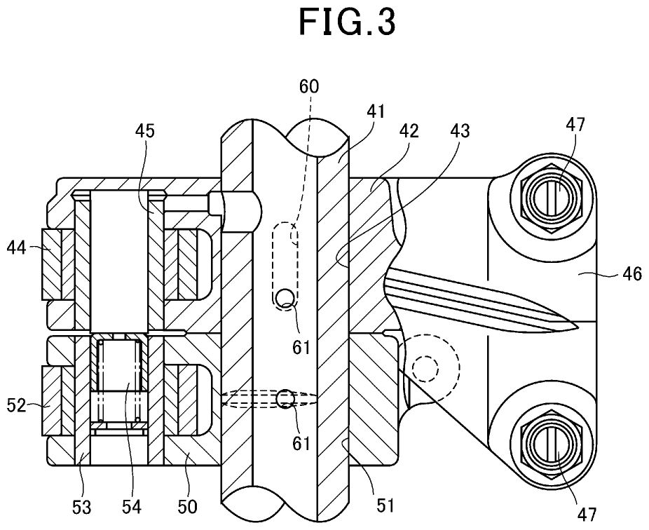

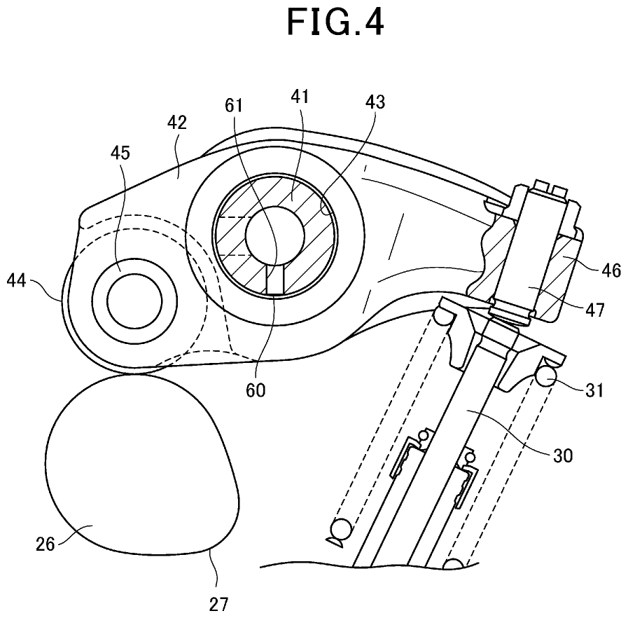

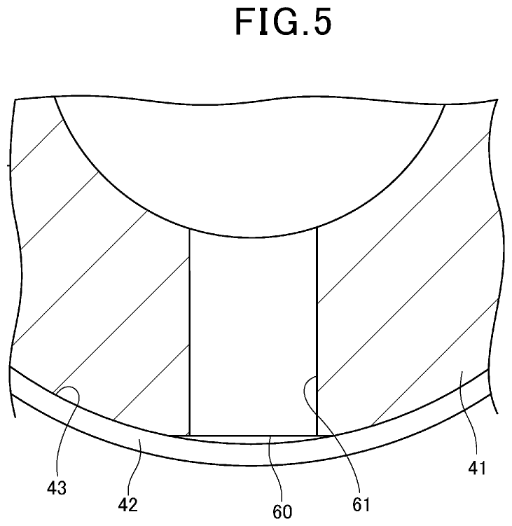

FIG. 3 is a plan view of a rocker arm portion of the present embodiment. FIG. 4 is a side view of a low-rotation rocker arm portion of the present embodiment. FIG. 5 is an enlarged cross-sectional view of a rocker shaft portion of the present embodiment.

As illustrated in FIGS. 3 and 4, the engine 10 includes rocker arms 40 that perform opening and closing operations of the intake valves 22 and the exhaust valves 24.

Note that the following describes the configuration of a rocker arm 40 for driving an intake valve 22.

The intake valve 22 has a valve shaft 30. The intake valve is configured such that the urging force of a spring 31 seeks to hold the intake valve 22 in the state in which the intake valve 22 closes the intake port 23.

Above the cam shaft 26 are provided rocker shafts 41 extending approximately in parallel with the cam shaft 26. The rocker shaft 41 supports a low-rotation rocker arm 42 and a high-rotation rocker arm 50 positioned side by side such that they are swingable.

The low-rotation rocker arm 42 includes a shaft bearing portion 43 in which the rocker shaft 41 is inserted, and the low-rotation rocker arm 42 has a shape extending on both sides of the shaft bearing portion 43.

The low-rotation rocker arm 42 has, at its end on the cam shaft 26 side, a contact roller 44 that is in contact with the outer peripheral surface of a cam 27 of the cam shaft 26 and is rotatably attached by a roller support shaft 45.

The roller support shaft 45, which supports the contact roller 44 of the low-rotation rocker arm 42, is formed to have a cylindrical shape the inside of which is hollow.

The low-rotation rocker arm 42 has, on the side near the valve shaft 30 of the intake valve 22, a valve push plate 46 corresponding to the upper end portions of the pair of valve shafts 30.

The valve push plate 46 is formed to be offset from the low-rotation rocker arm 42 so as to extend from one side which is the low-rotation rocker arm 42 side to the other side which is the high-rotation rocker arm 50 side.

The valve push plate 46 has valve push members 47 attached such that they pass through the valve push plate 46. The valve push members 47 come into contact with the upper end portions of the valve shafts 30.

The high-rotation rocker arm 50 includes a shaft bearing portion 51 in which the rocker shaft 41 is inserted, and the high-rotation rocker arm 50 has a shape extending on both sides of the rocker shaft 41.

The high-rotation rocker arm 50 has, at its end on the cam shaft 26 side, a contact roller 52 that is in contact with the outer peripheral surface of a cam 27 of the cam shaft 26 and is rotatably attached by a roller support shaft 53.

The roller support shaft 53, which supports the contact roller 52 of the high-rotation rocker arm 50, is formed to have a cylindrical shape the inside of which is hollow.

The roller support shaft 45 of the low-rotation rocker arm 42 and the roller support shaft 53 of the high-rotation rocker arm 50 communicate with each other in the normal state, and in each of the roller support shafts 45 and 53 is provided a stopper 54. Inside of each of the roller support shafts 45 and 53 is provided a not-illustrated connection pin movable in the axial direction.

In the state in which the engine 10 is driven at low rotation speed, the connection pin is positioned inside the roller support shaft 45. In this state, only the low-rotation rocker arm 42 is driven by the cam shaft 26.

With this configuration, during the low-rotation-speed drive of the engine 10, the intake valves 22 are driven in the low-lift state in which their lift distance is small.

During the high-rotation-speed drive of the engine 10, when the connection pin is hydraulically positioned at a position where the connection pin is engaged with the stoppers 54, the low-rotation rocker arm 42 and the high-rotation rocker arm 50 are driven together.

With this configuration, the intake valves 22 are driven in the high-lift state in which their lift distance is large.

In the present embodiment, as illustrated in FIG. 5, the rocker shaft 41 has an oil holding portion 60 at a position corresponding to the low-rotation rocker arm 42 and on the lower surface side of the rocker shaft 41, the oil holding portion 60 having a shape formed by cutting a portion of the peripheral surface of the rocker shaft 41 in the axial direction. The oil holding portion 60 is formed to be shorter than the dimension of the low-rotation rocker arm 42 in the axial direction.

The rocker shaft 41 is formed to have a cylindrical shape the inside of which is hollow, and the rocker shaft 41 has a plurality of oil supply holes 61 that pass through in the radial direction.

At least one of these oil supply holes 61 is formed to be open to the oil holding portion 60.

Next, advantageous effects of the present embodiment will be described.

In the present embodiment, in the state in which the engine 10 is driven at low rotation speed, only the low-rotation rocker arm 42 is driven by the cam shaft 26.

In this case, oil is supplied through the oil supply holes 61, and oil is held in the oil holding portion 60.

This configuration allows oil to be held on the lower surface side of the rocker shaft 41 where the load to the rocker shaft 41 is largest around the rocker shaft 41.

Providing the oil holding portion 60 makes it possible to supply oil to the entire area of a portion of the low-rotation rocker arm 42, the portion corresponding to the rocker shaft 41, even under low oil pressure and high load conditions.

Since oil is directly supplied through an oil supply hole 61 to the oil holding portion 60 formed on the lower surface side of the rocker shaft 41 where a load is exerted, unlike conventional techniques in which an annular oil groove is formed on the outer periphery of the rocker shaft 41, oil does not leak out, and the oil pressure does not decrease, even in the case in which the low-rotation rocker arm 42 is formed of a material having a high coefficient of linear expansion.

Note that if the width dimension of the oil holding portion 60 is set longer than the width dimension of the low-rotation rocker arm 42, there is a possibility of oil leakage. However, in the present embodiment, since the width dimension of the oil holding portion 60 is shorter than the width dimension of the low-rotation rocker arm 42, oil will not leak out.

When the engine 10 rotates at high rotation speed, the connection pin is positioned at a position where it engages with both the roller support shaft 45 of the low-rotation rocker arm 42 and the roller support shaft 53 of the high-rotation rocker arm 50, and thus, the low-rotation rocker arm 42 and the high-rotation rocker arm 50 are driven together. This makes it possible to drive the intake valves 22 in the high-lift state in which their lift distance is large.

As has been described above, an engine in the present embodiment includes: a crankshaft disposed vertically; a piston 16 that is connected to the crankshaft via a connecting rod 17 and reciprocates in a cylinder 15; a cylinder head 20 forming a combustion chamber 21 of the cylinder 15 at an end face of a movable portion of the piston 16; an intake valve 22 and an exhaust valve 24 disposed at the cylinder head 20, the intake valve 22 being configured to take in fuel-air mixture, which is a mixture of fuel and air, the exhaust valve 24 being configured to exhaust the fuel-air mixture; a low-rotation rocker arm 42 (rocker arm) that drives the intake valve 22 and the exhaust valve 24 by rotation of a cam shaft 26; and a rocker shaft 41 that supports the low-rotation rocker arm 42 such that the low-rotation rocker arm 42 is swingable, and an oil holding portion 60 extending in an axial direction of the rocker shaft 41 is provided between the rocker shaft 41 and the low-rotation rocker arm 42.

With this configuration, providing the oil holding portion 60 makes it possible to hold oil on the lower surface side of the rocker shaft 41 where the load to the rocker shaft 41 is largest around the rocker shaft 41, to prevent the occurrence of oil leakage, and to supply oil to the entire area of a portion of the low-rotation rocker arm 42, the portion corresponding to the rocker shaft 41, even under low oil pressure and high load conditions.

In the present embodiment, the oil holding portion 60 communicates with an oil supply hole 61.

With this configuration, since the oil holding portion 60 communicates with the oil supply hole 61, it is possible to lubricate the low-rotation rocker arm 42 effectively.

In the present embodiment, the oil holding portion 60 is formed on an outer peripheral surface of the rocker shaft 41.

With this configuration, the oil holding portion 60 formed on the rocker shaft 41 makes it possible to hold oil on the lower surface side of the rocker shaft 41 where the load to the rocker shaft 41 is largest.

In the present embodiment, the oil holding portion 60 has a length shorter than a width dimension of the low-rotation rocker arm 42 (rocker arm).

With this configuration, since the width dimension of the oil holding portion 60 is shorter than the width dimension of the rocker arm, the occurrence of oil leakage can be prevented.

In the present embodiment, the width of the oil holding portion 60 in the circumferential direction of the low-rotation rocker arm 42 (rocker arm) is approximately the same as the diameter of an oil supply hole.

If the width of the oil holding portion 60 in the circumferential direction of the low-rotation rocker arm 42 is smaller than the diameter of the oil supply hole, the lubrication area is very small. If the width of the oil holding portion 60 in the circumferential direction of the low-rotation rocker arm 42 is larger than the diameter of the oil supply hole, lubrication oil more than necessary is retained in the oil holding portion 60. In addition, the larger the width of the oil holding portion 60 in the circumferential direction of the low-rotation rocker arm 42, the more the stress is concentrated at the end portions of the oil holding portion 60, and thus it is not appropriate. Since the width of the oil holding portion 60 in the circumferential direction of the low-rotation rocker arm 42 is approximately the same as the diameter of the oil supply hole, such problems can be avoided.

In the present embodiment, the oil holding portion 60 has an approximately oval shape extending in an axial direction of the low-rotation rocker arm 42 (rocker arm), and the width of the oil holding portion 60 in the circumferential direction is the same as the diameter of the oil supply hole 61.

With this configuration, since the oil holding portion 60 has an approximately oval shape extending in the axial direction of the low-rotation rocker arm 42, and the width of the oil holding portion 60 in the circumferential direction is the same as the diameter of the oil supply hole, it is possible to achieve a very reasonable manufacturing cost in the manufacturing process of the oil holding portion 60 because in the case of a casting process, the shape only needs to be reflected in the mold, and in the case of a cutting process, the shape can be achieved only by cutting once so as to be adapted to the diameter of the supply hole.

In the present embodiment, the rocker arm includes low-rotation and high-rotation rocker arms 42 and 50 of the engine 10, and the oil holding portion 60 is formed at a portion corresponding to the low-rotation rocker arm 42.

With this configuration, although the oil pressure is low when the engine 10 is running at low rotation speed, it is possible to supply and hold oil even in the low-rotation-speed operation of the engine 10 because the oil holding portion 60 is provided at a position corresponding to the low-rotation rocker arm 42.

Use of an engine with the foregoing configuration in an outboard motor and use of this outboard motor in a watercraft provide an outboard motor or a watercraft in which oil can be supplied and held even in the low-rotation-speed operation of the engine 10.

Next, a modification example of the present invention will be described.

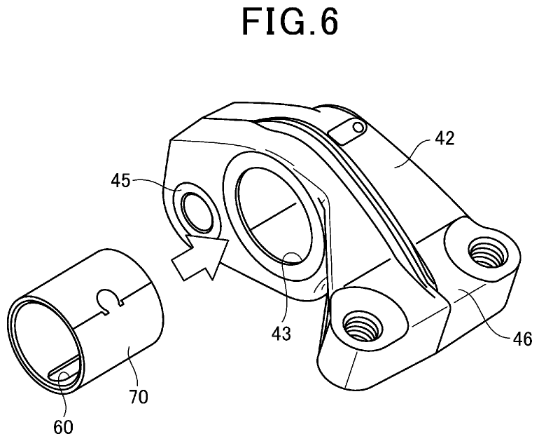

FIG. 6 is a perspective view of a modification example of the present invention.

As illustrated in FIG. 6, a wound bush member 70 is used in the present embodiment. The wound bush member 70 is formed by rolling up a flat plate material into an annular shape.

The wound bush member 70 is inserted to fit into the inner peripheral surface of the shaft bearing portion 43 of the low-rotation rocker arm 42.

The inner peripheral surface of the wound bush member 70 has an oil holding portion 60.

This modification example makes it possible to form an oil holding portion 60 between the wound bush member 70 and the rocker shaft 41 without performing a process on the low-rotation rocker arm 42 and the rocker shaft 41.

With this configuration, it is possible to hold oil on the lower surface side of the low-rotation rocker arm 42.

Although the present invention has been described based on the embodiment, the present invention is not limited to the foregoing embodiment, but various kinds of change, replacement, addition, elimination, and the like are possible as necessary.

### REFERENCE SIGNS LIST

10 engine
11 crank room
12 crank case
13 crankshaft
14 cylinder block
15 cylinder
16 piston
17 connecting rod
20 cylinder head
21 combustion chamber
22 intake valve
23 intake port
24 exhaust valve
25 exhaust port
26 cam shaft
27 cam
30 valve shaft
40 rocker arm
41 rocker shaft
42 low-rotation rocker arm
43, 51 shaft bearing portion
44, 52 contact roller
45, 53 roller support shaft
46 valve push plate
47 valve push member
50 high-rotation rocker arm
54 stopper
60 oil holding portion
61 oil supply hole
70 wound bush member

What is claimed is:

1. An engine comprising:
a crankshaft disposed vertically;
a piston that is connected to the crankshaft via a connecting rod and reciprocates in a cylinder;
a cylinder head forming a combustion chamber of the cylinder at an end face of a movable portion of the piston;
an intake valve and an exhaust valve disposed at the cylinder head, the intake valve being configured to take in fuel-air mixture, which is a mixture of fuel and air, the exhaust valve being configured to exhaust the fuel-air mixture;
a rocker arm that drives the intake valve and the exhaust valve by rotation of a cam shaft; and
a rocker shaft that supports the rocker arm such that the rocker arm is swingable, wherein
an oil holding portion extending in an axial direction of the rocker shaft is provided between the rocker shaft and the rocker arm.

2. The engine according to claim 1, wherein
the oil holding portion communicates with an oil supply hole.

3. The engine according to claim 1, wherein
the oil holding portion is formed on an outer peripheral surface of the rocker shaft.

4. The engine according to claim 3, wherein
the oil holding portion has a length shorter than a width dimension of the rocker arm.

5. The engine according to claim 3, wherein
the width of the oil holding portion in the circumferential direction of the rocker arm is approximately the same as the diameter of an oil supply hole.

6. The engine according to claim 5, wherein
the oil holding portion has an approximately oval shape extending in an axial direction of the rocker arm, and
the width of the oil holding portion in the circumferential direction is the same as the diameter of the oil supply hole.

7. The engine according to claim 1, wherein
a wound bush member is provided on a surface of the rocker arm, the surface being configured to slide on the rocker shaft, and
the oil holding portion is formed in the wound bush member.

8. The engine according to claim 1, wherein
the rocker arm includes low-rotation and high-rotation rocker arms of the engine, and
the oil holding portion is formed at a portion corresponding to the low-rotation rocker arm.

9. An outboard motor comprising the engine according to claim 1.

10. A watercraft comprising the outboard motor according to claim 9.
